(19) United States
(12) Patent Application Publication
(10) Pub. No.: US 2008/0060461 A1
(43) Pub. Date: Mar. 13, 2008

(54) Gear-Changing Device

(76) Inventor: Bernd-Robert Hohn, Munchen (DE)

Correspondence Address: TUCKER ELLIS & WEST LLP, 1150 HUNTINGTON BUILDING, 925 EUCLID AVENUE, CLEVELAND, OH, 44115-1414, US

(21) Appl. No.: 11/815,640

(22) PCT Filed: Feb. 7, 2006
(86) PCT No.: PCT/EP06/01051

§ 371 Date: Aug. 6, 2007

(30) Foreign Application Priority Data
Feb. 8, 2005 (DE) 10 2005 005 693.8

(51) Int. Cl. F16H 63/32

(52) U.S. Cl. 74/331

(57) ABSTRACT

A gear-changing device for a speed-changing transmission, in particular for motor vehicles, includes at least two pot-shaped gearwheels rotatably borne on a transmission shaft and a synchronizer clutch adapted to alternately couple the respective gearwheels with the transmission shaft. A sliding sleeve of the synchronizer clutch is displaceable over respective synchronizer rings, each having locking gear teeth, onto respective gear-selecting gear teeth of the gearwheels by actuation of a gear-changing rocker, which contacts diametrically opposing positions of the sliding sleeve. The two pot-shaped gearwheels have recesses facing towards each other and radially-outer gear rims. The gear-selecting gear teeth and, as much as possible the synchronizer clutch with the two synchronizer rings, are disposed in the recesses.

### CROSS-REFERENCE

This application is the US national phase of International application no. PCT/EP2006/001051 filed Feb. 7, 2006, which claims priority to German patent application no. 10 2005 005 693.8 filed Feb. 8, 2005.

### TECHNICAL FIELD

The invention concerns a gear-changing device for a speed-changing transmission, in particular for motor vehicles.

### BACKGROUND ART

A gear-changing device is known from DE 696 15 964 T2, wherein a gear-changing flange, which is axially displaceable and engages in a sliding sleeve, projects into a gap between two gear rims. The gear-changing flange takes the sliding sleeve with it when the gear-changing flange displaces. Therefore, the displacement path length of the gear-changing flange is as long as the displacement path length of the sliding sleeve. The axial width of the gap corresponds to this displacement path length.

A gear-changing device is also known from EP 0 819 864 A1, wherein the sliding sleeve, which is disposed between two gearwheels, is disposed radially inward and axially adjacent of the gear rim of a first gearwheel and adjacent to the gear rim of a second gearwheel, which latter gear rim has the same radius as the sliding sleeve.

In DE 199 01 067 A1, a gear-changing device is described that shifts between a forward-motion gearwheel and a rearward-motion gearwheel. A friction cone ring is disposed in a recess of the forward-motion gearwheel for starting the synchronization with the rearward-motion gearwheel. The friction cone ring cooperates together with a sliding sleeve, which is disposed between the gearwheels and radially inward of the gear rims of the gearwheels. The sliding sleeve has inner gear teeth that may be brought into engagement with the gear-selecting gear teeth of the rearward-motion gearwheel. The axial displacement of the gear-changing sleeve is effected by means of a gear-changing rocker that includes sliding blocks, which are disposed radially inward of the outer gear rims of the two gearwheels and perpendicular to the transmission axis. The sliding blocks are guided on diametrically-opposite locations of a circumferential groove of the sliding sleeve.

### SUMMARY OF THE INVENTION

An object of the invention is to provide an improved gear-changing device for a transmission of a motor vehicle, which preferably requires less installation space in the axial direction than known gear-changing devices.

In one aspect of the present teachings, a preferred gear-changing device for a speed-changing transmission, in particular for motor vehicles, includes at least first and second gearwheels rotatably supported on a transmission shaft, e.g., a drive shaft, and preferably are disposed so as to correspond to or mesh with respective gearwheels fixedly attached to another transmission shaft, e.g. a driven shaft. The first and second gearwheels have radially-outer gear rims and gear-selecting gear teeth disposed radially-inward thereof. A synchronizer clutch is disposed on the transmission shaft between the gearwheels and is adapted to selectively and/or alternately detachably couple the first gearwheel or the second gearwheel with the transmission shaft, thereby defining the operative gear ratio of the transmission. The synchronizer clutch includes a sliding sleeve and first and second synchronizer rings, each having locking gear teeth arranged to mesh with gear teeth disposed on an inner surface of the sliding sleeve. The sliding sleeve is displaceable over the locking teeth of the respective synchronizer rings onto the respective gear-selecting gear teeth of the gearwheels.

More particularly, the first and second gearwheels are preferably substantially pot-shaped so as to define a recess therein. The first and second gearwheels are disposed on the transmission shaft such that the recesses face towards each other. The gear-selecting gear teeth and the synchronizer clutch having the two synchronizer rings are preferably substantially or completely disposed in the recesses.

A gear-changing rocker is preferably also substantially or completely accommodated in the recesses. In addition, the gear-changing rocker preferably contacts or engages at diametrically-opposing locations of the sliding sleeve. An actuation part is preferably adapted to move, e.g., slidably displace, the sliding sleeve. The actuation part at least partially projects through a gap formed between the opposing gear rims of the first and second gearwheels. The actuation part is preferably pivotable about a pivot axis oriented approximately perpendicular to the transmission shaft and extending approximately tangential to the gear rims.

More particularly, by making the actuation part pivotable about an axis that extends between the gear rims and approximately tangentially to the gear rims, it is possible to narrow or reduce the axial gap between the gear rims. In this case, the gear-changing device, together with the gear rims that are switchably connectable to the transmission shaft by the gear-changing device, can be made shorter in the axial direction than known gear-changing devices.

The gear-changing rocker is disposed in the recesses of the gearwheels and radially-inward of the gear rims and the gear-changing rocker is movable by an actuation apparatus within an axially-narrow separation distance (a) between the gear rims. The inventive teachings are thus directed to integrating the synchronizer clutch of the gear-changing device substantially within the gear rims and thus to distinctly spatially-shortening the assembly of the gearwheels and the synchronizer clutch. For achieving this purpose, the recesses are dimensioned so that the sliding sleeve of the synchronizer clutch can be displaced from an intermediate position (i.e. a clutch open position) into respective opposing, selectable gear positions.

As a consequence of structurally and spatially integrating the gear-changing rocker within the recesses of the opposing gearwheels, it is only necessary to actuate the gear-changing rocker from outside of the gear rims in order to change the operative gear, thereby resulting in a more compact gear-changing device.

In an advantageous preferred embodiment, the gear-changing rocker may be retained on an actuation apparatus that is rotatably supported in a transmission housing, so as to pivot about a pivotal axis, which is defined in the region of the gear rims of the gearwheels. Since the gear-changing rocker is pivotable, the gearwheels can be moved especially close to each other, because only the spatial clearance needed for the actuation apparatus (e.g., a pivotal axis) is required to be provided between the gear rims, independent of the required displacement path length of the sliding sleeve.

Thus, the gear-changing rocker can, especially advantageously, be securely linked with an actuation part of the actuation apparatus, which actuation part is preferably formed as a flat-rolled steel bar. In this case, the narrow side of the actuation part preferably projects between the gear rims of the gearwheels in an approximately tangentially-extending manner. As a result, the actuation part requires only an especially narrow separation distance and/or clearance space between the gear rims of the gearwheels. The gear rims can thus, if need be, also be formed wider, which would serve to provide a larger overlap or coverage of the running gear teeth for diagonally-arranged gear teeth.

Rotationally-symmetric bearing pins can be attached to and/or welded on both sides of the actuation part for the necessary rotatable support of the actuation apparatus in the housing of the transmission.

Further, in a particularly cost-effective manufacturing process, the gear-changing rocker and the actuation part can be manufactured as sheet metal parts and can be securely linked with each other and/or can be joined to a structural unit.

In accordance with a known roller bearing of the couplable gearwheels, the roller bearing can preferably be formed as axially- and radially-acting, two-row roller bearings that are arranged in an O-arrangement. This arrangement achieves a particularly stiff bearing of the pot-shaped gearwheels, which results in a highly smooth running performance of the running gear teeth. In addition, efficiency losses can be avoided that could arise, in some cases, as a result of axial contact of adjacent transmission elements, e.g., further gear-selecting gearwheels.

From the standpoint of an especially advantageous manufacturing technology and structural design, the roller bearings can be diagonal-shouldered contact ball bearings. The radially-outward facing annular bearing surfaces for the ball bearings may be formed directly in the hub section of the gearwheel.

The gearwheels can, especially advantageously, have running gear teeth with a lower tooth height and/or smaller modules than conventional gear teeth for a comparable transmission output power. In addition to achieving an improved efficiency in the drive transmission, by reducing the necessary height or size of the outward-facing gear teeth, the radial clearance space within the pot-shaped recesses inside of the couplable gearwheels can be made larger for the synchronizer clutch and, if need be, for the gear-changing fork.

The synchronizer clutch can include an outer- or inner-synchronizer ring in a known manner. However, a double-cone clutch having both an inner cone and an outer cone is preferably utilized, which double-cone clutch also ensures a reliable and robust synchronization when changing the gears under especially-restrictive spatial conditions.

Finally, a particular preferable usage of a plurality of the aforementioned gear-changing devices in a speed-changing transmission for motor vehicles is proposed. More specifically, when six transmission ratio steps and/or six couplable gearwheels, which correspond with respective gearwheels fixedly disposed on one or two drive or driven shafts, is desired, all aforementioned gearwheels may be disposed between only two roller bearings provided for rotatably supporting the transmission shafts in the transmission housing. That is, when using a plurality of gear-changing devices, which have an especially short construction in the axial direction, a six-gear transmission can be installed in a conventional transmission housing for a four-gear transmission. More particularly, each transmission shaft can be supported by only a double bearing. As a result, an intermediate bearing having, if need be, an additional transmission cover, which are required in conventional transmissions, can be advantageously omitted in accordance with the present teachings.

An embodiment of the invention will be explained with further details in the following.

### BRIEF DESCRIPTION OF THE DRAWINGS

FIG. 1 shows a longitudinal cross-section along line I-I of FIG. 2 through a gear-changing device in a speed-changing transmission for motor vehicles, the gear-changing device having two couplable gearwheels and an integrated synchronizer clutch;

FIG. 2 shows a cross-section along line II-II of FIG. 1 through the gear-changing device; and

FIG. 3 shows a three-dimensional illustration of the gear-changing device according to FIGS. 1 and 2, with partially broken-away gearwheels.

### DETAILED DESCRIPTION OF THE PRESENTLY PREFERRED EMBODIMENTS

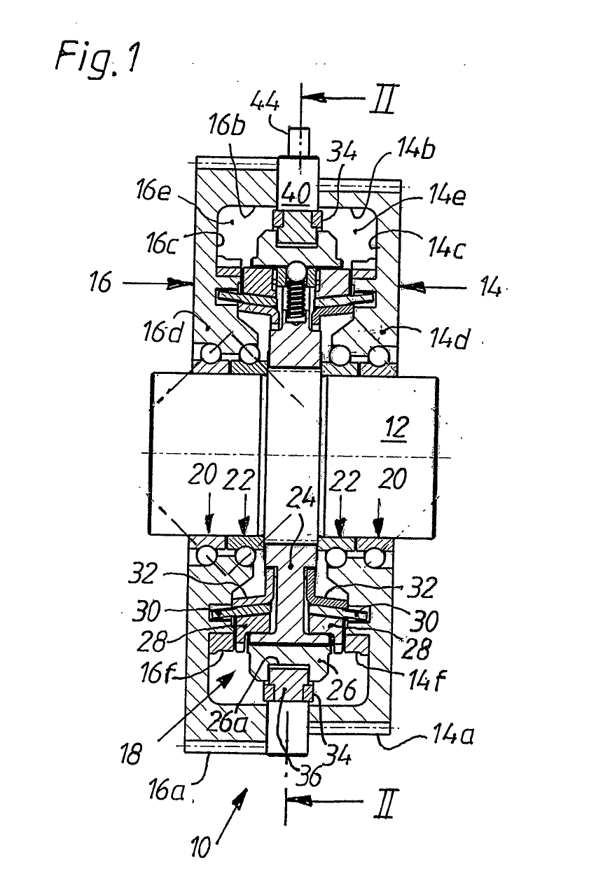

The gear-changing device 10 according to FIGS. 1 to 3 is part of a speed-changing transmission and/or a manually-shifted transmission for motor vehicles, wherein a drive shaft 12 is visible in section, which drive shaft 12 is rotatably supported by means of two roller bearings (not shown) in the transmission housing of the transmission. A driven shaft is likewise rotatably supported by two roller bearings parallel to the drive shaft. To the extent it is not illustrated and described, the transmission and/or manually-shifted transmission is of known construction.

Three gear-changing devices 10 as described below are provided on the drive shaft 12, and if need be on the driven shaft, for forming six forward-motion gears.

The gear-changing device 10 is basically composed of two gearwheels 14, 16, which are rotatably borne on and are releasably couplable to the drive shaft 12, and a synchronizer clutch 18 integrated in the gearwheels 14, 16. The running gear teeth 14a, 16a of the gearwheels 14, 16 engage with not-illustrated gearwheels fixed on the driven shaft of the transmission; however, this arrangement can also be reversed.

Each gearwheel 14, 16 is pot-shaped and has an outer gear rim 14b, 16b carrying the running gear teeth 14a, 16a, a radially-extending flange section 14c, 16c and a radially-inner hub section 14d, 16d.

The gearwheels 14, 16 are rotatably supported on the drive shaft 12 by means of radially- and axially-supporting, two-row roller bearings and/or diagonal-shouldered contact ball bearings 20, 22, wherein the radially-outward-facing annular paths of the ball bearings 20, 22, as is apparent, are cut directly into the hub sections 14d, 16d. As is also apparent, the roller bearings and/or ball bearings 20, 22 are thus oriented in an O-arrangement (see the dotted lines in FIG. 1), whereby a relatively-wide bearing-support base for the gearwheels 14, 16 and a suitably stiff bearing on the drive shaft 12 is provided.

The synchronizer clutch 18 is disposed between the two gearwheels 14, 16 in the recesses 14e, 16e, which face towards each other and which are formed by the pot-shaped design of the gearwheels 14, 16; the synchronizer clutch 18 is basically composed of a radially-inward clutch body 24, an outer sliding sleeve 26 and two synchronizer rings 28 axially adjacent to the clutch body 24.

The clutch body 24 is retained on the drive shaft 12 by means of spline teeth so as to rotate with the drive shaft 12; further, the sliding sleeve 26 is non-rotatably, but axially displaceably, guided along gear teeth formed on the clutch body 24. The sliding sleeve 26 can be displaced from the middle position shown in FIG. 1 (clutch open) towards the left or the right into a gear-engaged position, wherein the inner gear teeth of the sliding sleeve 26 are initially slid in an interlocking-manner over the locking gear teeth of the respective synchronizer ring 28 and then onto one of the gear-selecting gear teeth 14f, 16f, which are disposed radially-inward of the gear rims 14b, 16b; as a result of this displacement of the sliding sleeve 26 from the middle position (clutch open) to the left-most or right-most gear-engaged position, the corresponding gearwheel 14 or 16 is coupled with the drive shaft 12.

The synchronizer clutch 18 is preferably constructed as a known double-cone clutch, wherein the cone surfaces effecting the synchronization are formed not only on the synchronizer rings 28, but also on each intermediate ring 30 interlocked with the respective gearwheels 14, 16 and on inner rings 32 affixed to the clutch body 24. It should be noted that the construction and function of the synchronizer clutch 18, as far as it is not described, can be an embodiment known and familiar to the skilled person. A simple inner- or outer-synchronization (e.g., according to Borg Warner®) can also be utilized.

The actuation of the sliding sleeve 26 of the synchronizer clutch 18 is effected by means of a gear-changing rocker 34, which surrounds the sliding sleeve 26 by approximately 180 degrees. The gear-changing rocker 34 engages in an annular groove 26a of the sliding sleeve 26 via diametrically-contacting slide shoes 36. The slide shoes 36 are pivotably disposed on the ends of the gear-changing rocker 34.

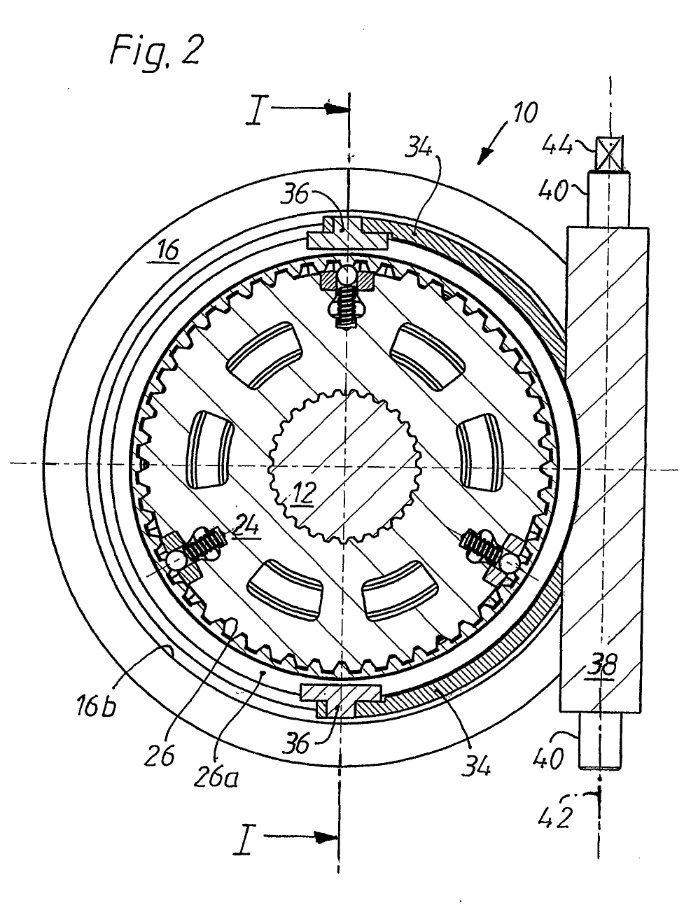

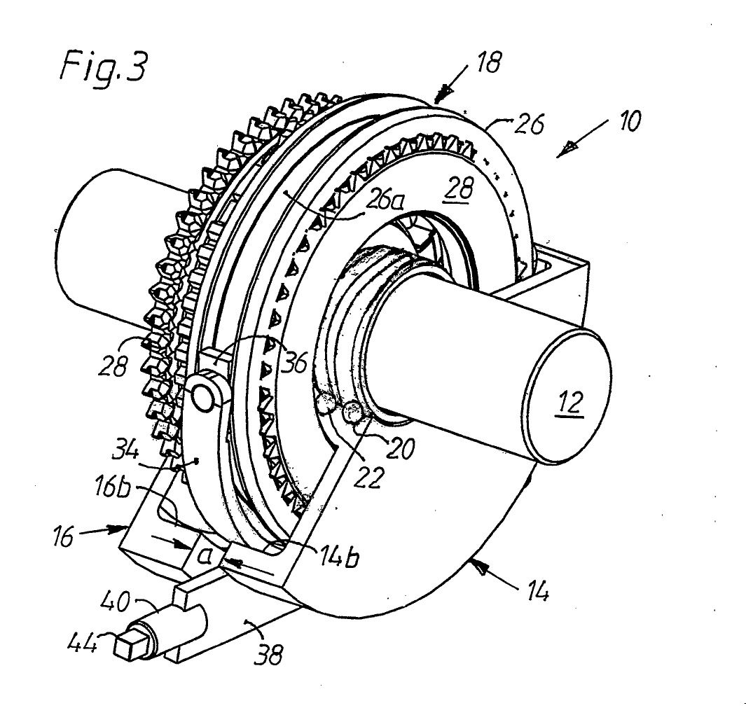

The gear-changing rocker 34 forms a structural unit with an actuation part 38, which is manufactured in the shape of a flat-rolled steel bar having a rectangular cross-section (see FIG. 3), and with rotationally-symmetric bearing pins 40 attached on the ends of the actuation part 38; the gear-changing rocker 34 is pivotable at the bearing pins 40 about the pivot axis 42 drawn in FIG. 2 by means of a not-illustrated actuation device for selecting the transmission ratio steps and/or gears.

The narrow side of the actuation part 38 thus projects approximately tangentially into a narrow annular gap and/or separation distance (a) between the mutually-opposing front sides of the gear rims 14b, 16b of the gearwheels 14, 16; the separation distance (a) takes into account the width of the actuation part 38 plus the small angular travel distance of its limited rotational range. The bearing pins 40 are rotatably supported in the surrounding transmission housing in a not-illustrated manner.

The rotation of the actuation part 38 is effected by means of a not-illustrated actuation device, e.g., by means of a lever contacting the square 44 formed on the bearing pin 40 or the like; the lever can be manually shiftable by means of a suitable linkage or can be automatically shiftable by means of actuators.

The pivotable gear-changing rocker 34 having the actuation part 38 is made from sheet metal parts into a structural unit that requires little installation space and, as is apparent, is disposed in the recesses 14e, 16e formed radially-inward of the gear rims 14b, 16b and/or is integrated in the gearwheels 14, 16.

This considerably reduces the axial installation space of the gear-changing device 10, wherein the gear rims 14b, 16b, as is apparent, project over the gear-selecting gear teeth 14f, 16f, over the synchronizer rings 28 and partially over the sliding sleeve 26 and the gear-changing fork 34.

The running gear teeth 14a, 16a of the gearwheels 14, 16 are constructed with a lower teeth height and/or smaller modules than conventional gear teeth for a comparable transmission output power. As is apparent from FIG. 1, this creates more installation space for the integration of the synchronizer clutch 18 and the gear-changing rocker 34 with smaller rolling losses in the running gear teeth 14a, 16a. Moreover, by using the ball bearings 20, 22, which also provide support in the axial direction, start-up contact losses are avoided between further transmission elements that are axially adjacent to the gearwheels 14, 16, such as e.g., further gearwheels.

The especially small axial installation space of the gear-changing device 10 makes possible the arrangement of three gear-changing devices 10 for realizing a manually-shifted transmission having six gears within an overall length that makes it possible to support the transmission shafts and/or the drive shaft 12 and the driven shaft (not illustrated) in the corresponding transmission housing with only two ball bearings each.

It is understood that all three gear-changing devices 10 are not required to be disposed on the drive shaft 12, but rather they can be disposed in a distributed manner on two transmission shafts in a known manner.

The exemplary-described gear-changing device can be modified in various ways. For example, the actuation part 38, whose rotational axis 42 extends approximately tangential to the gear rims 14b, 16b and perpendicular to the drive shaft 12 through the gap between the gearwheels, is not required to be constructed as one-piece with the gear-changing fork 34. Rather, it can, e.g., engage with a pin in a corresponding recess of the gear-changing fork, when the gear-changing fork is, for example, non-rotatably retained on the sliding blocks and the gear-changing fork is thereby only movable parallel to the drive shaft 12. It is important that the actuation part is pivotable substantially only in the gap space so that the axial width of the gap space can be substantially smaller than the displacement path length of the sliding sleeve as a result of the lever action and so that the gap space must only be somewhat larger than the thickness of the actuation part. The pivotal axis of the actuation member advantageously extends parallel to the connection line between the diametrically-opposing sliding shoes, which are, e.g., guided in a circumferential groove of the sliding sleeve.

1-11. (canceled)

12. A gear-changing device for a speed-changing transmission comprising:
at least a first gearwheel and a second gearwheel rotatably supported on a transmission shaft, each gearwheel having a radially-outer, cylindrical-shaped gear rim defining a inner recess, gear-selecting gear teeth disposed radially inward of the gear rim and outward-facing gear teeth disposed radially outward of the gear rim, which outward-facing gear teeth are arranged and constructed to correspond to respective gearwheels attached to another transmission shaft, the first and second gearwheels being arranged on the transmission shaft such that the respective inner recesses face each other and a gap is defined between the respective facing gear rims,
a synchronizer clutch disposed on the transmission shaft and at least substantially within the facing inner recesses of the first and second gearwheels, the synchronizer clutch including a sliding sleeve having gear teeth, a first synchronizer ring having locking gear teeth and a second synchronizer ring having locking gear teeth, the sliding sleeve being displaceable in the axial direction of the transmission shaft along the locking gear teeth of each respective synchronizer ring so as to engage the gear-selecting gear teeth of the respective gearwheels in order to detachably couple the first gearwheel or the second gearwheel with the transmission shaft and cause the coupled gearwheel to rotate together with the transmission shaft,
a gear-changing fork disposed at least substantially within the facing inner recesses of the first and second gearwheels and engaging the sliding sleeve at diametrically-opposing locations of the sliding sleeve, and
an actuation part projecting through the gap defined between the gear rims and being arranged and constructed to move the gear-changing fork so as to displace the sliding sleeve in the axial direction of the transmission shaft, the actuation part being pivotable about a pivot axis that is oriented approximately perpendicular to the transmission shaft and that extends approximately tangential to the gear rims.

13. A gear-changing device according to claim 12, wherein the gear-changing fork is rigidly linked with the actuation part.

14. A gear-changing device according to claim 13, wherein the gear-changing fork comprises pivotably-attached first and second slide shoes that are guided along the outer circumference of the sliding sleeve at diametrically-opposing locations thereof.

15. A gear-changing device according to claim 14, wherein the slide shoes are pivotable with respect to the gear-changing fork about respective axes extending approximately perpendicular to the outer circumference of the sliding sleeve.

16. A gear-changing device according to claim 15, wherein the actuation part is formed as a flat metal bar and wherein a narrow side of actuation part projects into the gap defined between the gear rims.

17. A gear-changing device according to claim 16, further comprising rotationally-symmetric bearing pins attached on both ends of the actuation part and being arranged and constructed to rotationally support the actuation part in a transmission housing.

18. A gear-changing device according claim 17, wherein the gear-changing fork and the actuation part are steel sheet parts joined together.

19. A gear-changing device according to claim 18, further comprising axially and radially supporting, dual-row ball bearings rotationally supporting the first and second gearwheels on the transmission shaft.

20. A gear-changing device according to claim 19, wherein the roller bearings contact diagonal-shoulders of respective hub sections of the first and second gearwheels.

21. A gear-changing device according to claim 20, wherein outer bearing surfaces of the roller bearings are formed directly in the respective hub sections of the first and second gearwheels.

22. A gear-changing device according to claim 21, wherein the synchronizer clutch is formed as a double cone clutch having each of an inner cone and an outer cone.

23. A gear-changing device according to claim 12, wherein the gear-changing fork comprises pivotably-attached first and second slide shoes that are guided along the outer circumference of the sliding sleeve at diametrically-opposing locations of the sliding sleeve.

24. A gear-changing device according to claim 12, wherein the actuation part is formed as a flat metal bar and wherein a narrow side of actuation part projects into the gap defined between the gear rims.

25. A gear-changing device according to claim 12, further comprising axially and radially supporting, dual-row ball bearings rotationally supporting the first and second gearwheels on the transmission shaft.

26. A gear-changing device according to claim 25, wherein the roller bearings contact diagonal-shoulders of respective hub sections of the first and second gearwheels.

27. A gear-changing device according to claim 26, wherein bearing surfaces of the roller bearings are formed directly in radially-inward-facing surfaces of hub sections of the first and second gearwheels.

28. A speed-changing transmission for a motor vehicle having at least three gear-changing devices according to claim 12 disposed along the transmission shaft, which is rotationally supported in a transmission housing by only first and second roller bearings respectively disposed at opposite ends of the transmission shaft.

29. A gear-changing device for a speed-changing transmission comprising:
at least a first gearwheel and a second gearwheel rotatably supported on a transmission shaft, each gearwheel including a radially-outer, cylindrical-shaped gear rim, a recess defined within the gear rim, gear-selecting gear teeth disposed radially inward of the gear rim and transmission-ratio-defining gear teeth disposed radially outward of the gear rim, wherein the transmission-ratio-defining gear teeth are arranged and constructed to correspond to transmission-ratio-setting gear teeth of respective gearwheels attached to another transmission shaft and the first and second gearwheels are arranged on the transmission shaft such that the respective recesses face each other and a gap is defined between the respective facing gear rims,
a synchronizer clutch disposed on the transmission shaft and at least substantially within the facing recesses of the first and second gearwheels, the synchronizer clutch including a sliding sleeve having radially-inward-facing gear teeth, a first synchronizer ring having radially-outward-facing gear teeth and a second synchronizer ring having radially-outward-facing gear teeth, the sliding sleeve being slidably displaceable in the axial direction of the transmission shaft along the gear teeth of each respective synchronizer ring and being engagable with the gear-selecting gear teeth of the respective gearwheels so as to detachably couple one of the first gearwheel and the second gearwheel with the transmission shaft, whereby the coupled gearwheel rotates together with the transmission shaft,
a gear-changing fork disposed at least substantially radially-inward of the gear rims and within the facing recesses of the first and second gearwheels and contacting diametrically-opposing locations of the sliding sleeve, and
a pivotable lever projecting through the gap defined between the gear rims and being arranged and constructed to move the gear-changing fork so as to slidably displace the sliding sleeve in the axial direction of the transmission shaft, the pivotable lever being pivotable about a pivot axis that is oriented approximately perpendicular to the transmission shaft and that extends approximately tangential to the gear rims.

30. A gear-changing device according to claim 29, wherein:
the gear-changing fork comprises pivotably-attached first and second slide shoes that are in contact with the outer circumference of the sliding sleeve at diametrically-opposing locations thereof,
the pivotable lever is in the form of a flat metal bar having cylindrical pins disposed on opposite ends thereof for pivotably supporting the pivotable lever in a transmission housing, and
each gear wheel comprises a hub supporting the gear wheel on the transmission shaft, wherein a radially-inward-facing bearing surface is formed on each hub and ball bearings are disposed between the radially-inward facing surface and the transmission shaft and wherein the gear-selecting gear teeth are formed on a radially-outward facing surface of the hub.

31. A gear-changing device according to claim 30, wherein the ball bearings contact diagonal-shoulders of respective hub sections of the first and second gearwheels and the synchronizer clutch is formed as a double cone clutch having each of an inner cone and an outer cone.
